(19) United States
(12) Patent Application Publication
(10) Pub. No.: US 2021/0242450 A1
(43) Pub. Date: Aug. 5, 2021

(54) SILICON-CARBON-GRAPHENE COMPOSITE AND MANUFACTURING METHOD THEREOF, AND LITHIUM ION SECONDARY BATTERY USING THE SAME

(71) Applicant: Korea Institute Of Geoscience And Mineral Resources, Daejeon (KR)

(72) Inventors: Hee Dong JANG, Daejeon (KR); Han Kwon CHANG, Daeje (KR); Sun Kyung KIM, Sejong-si (KR)

(73) Assignee: Korea Institute Of Geoscience And Mineral Resources, Daejeon (KR)

(21) Appl. No.: 17/034,499

(22) Filed: Sep. 28, 2020

(30) Foreign Application Priority Data
Feb. 5, 2020 (KR) 10-2020-0013673

(51) Int. Cl. H01M 4/36; H01M 10/0525; H01M 4/587; H01M 4/38; C04B 35/524; C04B 35/64; C04B 35/626

(52) U.S. Cl. CPC H01M 4/364; H01M 10/0525; H01M 4/587; H01M 4/386; H01M 2004/021; C04B 35/64; C04B 35/6261; C04B 35/6268; C04B 35/62675; C04B 35/524

(57) ABSTRACT

The present disclosure provides a method for manufacturing a silicon-carbon-graphene composite comprising, preparing a suspension in which silicon, carbon source and graphene oxide are dispersed, subjecting the suspension to an aerosol process to form a silicon-carbon source-graphene oxide composite and heat-treating the silicon-carbon source-graphene oxide composite to form a silicon-carbon-graphene composite, and prevents direct contact of the electrolyte, so it can exhibit excellent cycling performance and stability.

### CROSS-REFERENCE TO RELATED APPLICATION

This present application claims benefit of priority to Korean Patent Application No. 10-2020-0013673, entitled “SILICON-CARBON-GRAPHENE COMPOSITE AND MANUFACTURING METHOD THEREOF, AND LITHIUM ION SECONDARY BATTERY USING THE SAME,” filed on Feb. 5, 2020, in the Korean Intellectual Property Office, the entire disclosure of which is incorporated herein by reference.

### TECHNICAL FIELD

The present disclosure relates to a silicon-carbon-graphene composite and a manufacturing method thereof, and a lithium ion secondary battery using the same.

### BACKGROUND ART

Until now, lead-acid batteries, nickel cadmium (Ni—Cd) batteries, nickel metal hydride (Ni-MH) batteries, and the like have been frequently used as small-sized secondary batteries. Recently, with the increasing trend of development of portable wireless electronic products, the necessity for a secondary battery having a high energy density is increasing for miniaturization and improvement of these products. Among various secondary batteries, lithium-ion secondary batteries have attracted attention in the energy industry as the main energy source for portable electronic devices, hybrid vehicles, etc. due to their high output and high energy characteristics.

Initial lithium-ion secondary batteries used lithium metal as a anode material, but the dendrites of lithium metal were precipitated during repeated charge/discharge, stability problems and non-reversibility problems inside the battery frequently occurred, making it difficult to commercialize.

For these reasons, graphite was often used as a anode material, but graphite also showed a low theoretical capacity of 372 mAh/g, so research on alternative anode materials with better capacity was needed.

Among them, since silicon has high theoretical capacity of 4200 mAh/g, low discharge potential, and non-toxic properties, it was expected to play an important role in the secondary battery market.

However, despite the high theoretical capacity, when silicon is used as the anode material of a lithium ion secondary battery, volume expansion of about 400% occurs in the process of insertion and desorption of lithium ions in the electrode during charging/discharging, which causes pulverization of the active material. At this time, due to additionally formed solid electrolyte interphase (SEI) layers or electrically short-circuited parts, there is a problem that the resistance increases, the capacity decreases abruptly, the electric conductivity decreases, and the lifetime characteristics of the electrode deteriorate, thus making it difficult to commercialize.

In order to solve these problems, a method of combining silicon and carbon-based materials capable of accepting large volume expansion and applying them as anode materials for a lithium ion secondary battery has been studied.

In order to improve the performance of a lithium ion secondary battery, the carbon-based materials used in the silicon-carbon composite are typically graphene, carbon nanotubes, activated carbon, etc., which are excellent in electrical conductivity and thermal conductivity and thus are attracting attention as energy storage materials.

When such a carbon-based material is mixed with silicon, it helps to buffer the large volume changes of silicon and exhibits improved electrochemical performance.

However, in the case of prior inventions and researches, silicon-carbon composites were prepared through liquefaction or hydrothermal reaction. However, in the case of the liquefaction or hydrothermal reaction, there was a drawback that it takes a long time of 24 hours or more, the process of the experiment is cumbersome, the uniformity of the product is low according to experimental conditions and thus, the particle size or composition ratio of the synthesized composite are different.

Therefore, there is a need for research to develop a composite for a anode material for a lithium ion secondary battery, which can increase excellent capacity and retention rate by using an easy and simple process.

In the present disclosure, a silicon-carbon-graphene composite including double carbon coating layers is prepared from silicon having various sizes, and applied as a anode material for a lithium ion secondary battery, thereby performing characteristic evaluation.

### PRIOR ART LITERATURE

### Patent Literature

(Patent Literature 1) Korean Patent Registration No. 10-1724196 (published on Apr. 6, 2017)

(Patent Literature 2) Korean Patent Registration No. 10-1818813 (published on Jan. 15, 2018)

### SUMMARY OF THE INVENTION

### Technical Problem

It is an object of the present disclosure to provide a silicon-carbon-graphene composite and a manufacturing method thereof, and a lithium ion secondary battery using the same.

The technical objects of the present disclosure are not limited to the aforementioned objects, and other objects, which are not mentioned above, will be apparent to a person having ordinary skill in the art from the following description.

### Technical Solution

In order to achieve the above-mentioned objects, an aspect of the present disclosure provides a method for manufacturing a silicon-carbon-graphene composite comprising the steps of: preparing a suspension in which silicon, carbon source and graphene oxide are dispersed (step 1); subjecting the suspension to an aerosol process to form a silicon-carbon source-graphene oxide composite (step 2); and heat-treating the silicon-carbon source-graphene oxide composite to form a silicon-carbon-graphene composite (step 3).

According to an embodiment of the present disclosure, the silicon in step 1 can be obtained from silicon sludge generated in silicon wafer manufacturing process.

According to an embodiment of the present disclosure, the silicon in step 1 can be obtained by pulverizing and dispersing silicon having an average particle size of 1 μm or more.

According to an embodiment of the present disclosure, the pulverization may be performed through one type of method selected from the group consisting of a bead mill, a basket mill, an attrition mill and a ball mill.

According to an embodiment of the present disclosure, the silicon in step 1 may have an average particle size of 50 nm to 1 μm.

According to an embodiment of the present disclosure, the carbon source in step 1 may include one or more selected from the group consisting of monosaccharides, disaccharides, polysaccharides, polyvinylpyrrolidone (PVP), polyethylene glycol (PEG), and polyvinyl alcohol (PVA).

According to an embodiment of the present disclosure, a mixing ratio of the silicon, carbon source and graphene oxide in step 1 may be 1.5:1:1.

According to an embodiment of the present disclosure, the aerosol process of step 2 may be performed through the steps of spraying the suspension with aerosol droplets through a nozzle and drying the sprayed material by passing through a tubular heating furnace via a carrier gas.

The carrier gas in step 2 may be one or more gases selected from the group consisting of argon, helium and nitrogen, and the flow rate of the carrier gas may be 5 L/min to 15 L/min.

In addition, the aerosol process in step 2 may be performed at a temperature of 150° C. to 250° C.

Meanwhile, in order to achieve the above-mentioned objects, another aspect of the present disclosure provides a silicon-carbon-graphene composite comprising: silicon, carbon and graphene, wherein the composite has a crumpled spherical shape including a carbon double coating layer in which the graphene and carbon are formed around silicon particles.

The average particle size of the silicon is 50 nm to 1 μm, and the average particle size of the silicon-carbon-graphene composite may be 2 μm to 3 μm.

In order to achieve the above-mentioned objects, yet another aspect of the present disclosure provides a anode material comprising a silicon-carbon-graphene composite, and a lithium ion secondary battery comprising the same.

### Advantageous Effects

When the silicon-carbon-graphene composite and a manufacturing method thereof, and a lithium ion secondary battery using the same according to the present disclosure are used, there is an advantage in that during the charging/discharging with a double carbon coating in the composite, it accepts the bulk expansion of the silicon and prevents direct contact of the electrolyte, so it can exhibit excellent cycling performance and stability.

The effects of the present disclosure are not limited to the effects described above, and are understood to include all effects that can be inferred based on the detailed description of the present disclosure or the invention described in the claims.

### BRIEF DESCRIPTION OF THE DRAWINGS

FIG. 1 is a process flow chart showing a method of manufacturing a silicon-carbon-graphene composite according to an embodiment of the present disclosure.

FIG. 2a to FIG. 2d show FE-SEM images of silicon raw materials based on a particle size (FIG. 2a 50 nm, FIG. 2b 100 nm, FIG. 2c 200 nm, FIG. 2d 1 μm).

FIG. 3a to FIG. 3d show FE-SEM images of the silicon-carbon-graphene composites based on particle sizes of silicon (FIG. 3a 50 nm, FIG. 3b 100 nm, FIG. 3c 200 nm, FIG. 3d 1 μm).

FIG. 4a to FIG. 4d are a graph showing the average particle size and distribution of silicon-carbon-graphene composites based on particle sizes of silicon (FIG. 4a 50 nm, FIG. 4b 100 nm, FIG. 4c 200 nm, FIG. 4d 1 μm).

FIG. 5 is a graph showing the results of XRD analysis of silicon-carbon-graphene composites prepared based on particle sizes of silicon ((a) 50 nm, (b) 100 nm, (c) 200 nm (d) 1 μm).

FIG. 6 is a graph showing the results of Raman spectroscopy analysis of silicon-carbon-graphene composites prepared based on particle sizes of silicon ((a) 50 nm, (b) 100 nm, (c) 200 nm (d) 1 μm).

FIG. 7a is a graph comparing the electric capacities of a lithium ion secondary batteries composed of silicon-carbon-graphene composites prepared based on silicon particle sizes.

FIG. 7b is a graph comparing the Coulombic efficiencies of a lithium ion secondary batteries composed of silicon-carbon-graphene composites prepared based on silicon particle sizes.

### DETAILED DESCRIPTION OF THE EMBODIMENTS

Advantages and features of the present disclosure, and methods of accomplishing the same will become apparent from the following embodiments in conjuction with the accompanying drawings. However, the present disclosure is not limited to the following embodiments, but may be implemented in different forms. The embodiments are provided only to complete disclosure of the present disclosure and to fully provide the scope of the disclosure to those skilled in the art, and the present disclosure will be defined only by the appended claims.

A shape, a size, a ratio, an angle, a number, and the like illustrated in the figures for describing the exemplary embodiments of the present disclosure are merely an example, and the present disclosure is not limited to the illustrated details. Like reference numerals generally denote like elements throughout the present specification.

Further, in the following description, when the detailed description of known related technologies is determined to unnecessarily obscure the subject matter of the present disclosure, the detailed description will be omitted.

The terms such as “including,” “having,” and “consist of” used herein are generally intended to allow other components to be added unless the terms are used with the term “only”. Any references to singular may include plural unless expressly stated otherwise.

The features of various embodiments of the present disclosure can be partially or entirely bonded to or combined with each other and can be interlocked and operated in technically various ways as can be fully understood by a person having ordinary skill in the art, and the embodiments can be carried out independently of or in association with each other.

Hereinafter, a method of manufacturing a silicon-carbon-graphene composite according to an aspect of the present disclosure will be described in detail for each step.

### Method for Manufacturing Silicon-Carbon-Graphene Composite

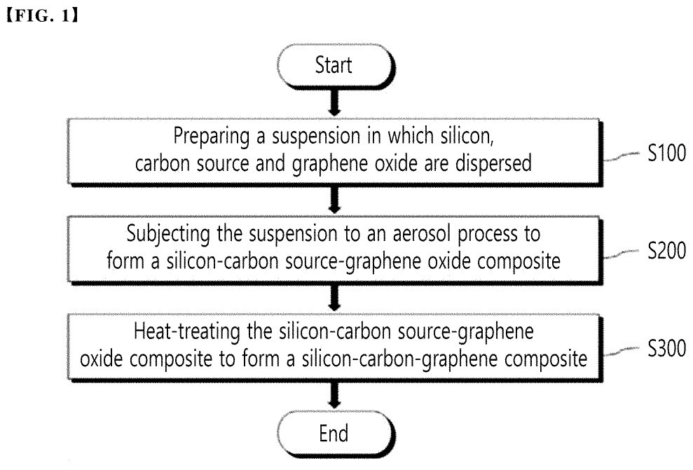

FIG. 1 is a process flow chart showing a method of manufacturing a silicon-carbon-graphene composite according to an embodiment of the present disclosure.

Referring to FIG. 1, the method of manufacturing a silicon-carbon-graphene composite according to the present disclosure comprises the steps of:

preparing a suspension in which silicon, carbon source and graphene oxide are dispersed (step 1) (S100);

subjecting the suspension to an aerosol process to form a silicon-carbon source-graphene oxide composite (step 2) (S200); and

heat-treating the silicon-carbon source-graphene oxide composite to form a silicon-carbon-graphene composite (step 3) (S300).

Hereinafter, the method of manufacturing a silicon-carbon-graphene composite according to the embodiments of the present disclosure will be described in detail for each step.

In the method of manufacturing a silicon-carbon-graphene composite according to the present disclosure, a suspension in which silicon, carbon source and graphene oxide are dispersed is prepared in step 1 (S100).

In step 1, silicon, a carbon source, graphene oxide, and a solvent can be mixed in a predetermined weight ratio to prepare a colloidal suspension.

As the silicone in step 1, a commercially available product can be used as it is, and any silicon can be used without limitation as long as it is ordinary silicon particles.

In addition, the silicon in step 1 may be prepared by pulverizing and dispersing silicon having an average particle size of 1 μm or more.

The silicon in step 1 may be generated in a silicon wafer manufacturing process for solar cells, or may be generated in the process of cutting or polishing a silicon wafer, or may be prepared by subjecting silicon sludge to acid-leaching, and optionally separating and recovering the silicon.

In the cutting process, a silicon sludge containing a large amount of silicon particles and a small amount of metal impurities may be generated.

The acid which can be used for the acid leaching to remove the small amount of metal impurities may include hydrochloric acid, sulfuric acid, nitric acid and the like, and preferably, hydrochloric acid may be used. In the case of mixed acids, there is a possibility that silicon is dissolved, which is thus not preferable.

The acid leaching can be performed by adding the waste silicon sludge to an acid solution.

The acid leaching solution may be cooled to room temperature, and after separating remaining liquid, washing can be performed by adding distilled water to the remaining waste silicon sludge.

After the acid leaching, solid-liquid separation may be performed through centrifugal separation and vacuum filtration, and then a drying step can be performed, and after the drying step, silicon can be recovered.

The recovered silicon may have a particle size of 1 μm to 5 μm.

The pulverization can be performed so that the average particle size of silicon is 50 nm to 1 μm. When the pulverization is performed so that the average particle size of the silicon is less than 50 nm, there may be a problem that a large number of silicon particles are aggregated and carbon coating cannot be easily performed. When the average particle size of the silicon exceeds 1 μm, cracking may occur during charging/discharging of the electrode including the composite prepared in a subsequent step.

The pulverization may be performed by one type of method selected from the group consisting of a bead mill, a basket mill, an attrition mill and a ball mill, and preferably may be performed by a bead mill using a metal oxide bead.

The average particle size of the silicon in step 1 may be 50 nm to 1 μm. When the average particle size of the silicon is within the above range, stress of the silicon due to volume expansion that occurs during the charging/discharging can be reduced, and reversible capacity can be increased.

Further, when the particle size of the silicon is less than the above range, loss of reversible capacity may occur, and when it exceeds the above range, cracking or pulverization of the silicone material occurs due to stress by volume expansion, resulting in a decrease in efficiency.

The carbon source of step 1 may serve as a main backbone in the composite, and is preferably a material that can be dissolved in a dispersion solution and carbonized through a firing process.

Further, the carbon source in step 1 may be coated onto the surface of silicon particles through a subsequent heat treatment process to form a carbon layer.

Specifically, the carbon source in step 1 is preferably a water-soluble material, and may include at least one selected from the group consisting of monosaccharides, disaccharides, polysaccharides, polyvinylpyrrolidone (PVP), polyethylene glycol (PEG) and polyvinyl alcohol (PVA).

The monosaccharide may be galactose, glucose, fructose, etc., the disaccharide may be sucrose, maltose and lactose, etc., and the polysaccharide may be dextran, starch, xylan, inulin, levan and galactan, and the like.

The carbon source in step 1 may include preferably monosaccharides, more preferably glucose.

As the graphene oxide in step 1, a commercially available product can be used as it is, and it may be prepared according to a conventional method for producing graphene oxide. Preferably, a graphene oxide produced by a modified Hummers method can be used.

In step 1, the mixed weight ratio of the silicon, carbon source, and graphene oxide may be 1 to 2:1:1, and preferably 1.5:1:1.

In step 1, the silicone may be included at a concentration of 0.1 to 0.5 wt %, preferably 0.3 wt % in the suspension. When the silicon concentration of the suspension is less than 0.1 wt %, there is a a possibility that the electrostatic capacitance of the composite manufactured through the subsequent steps is reduced rapidly, and when the silicon concentration of the mixed solution exceeds 0.5 wt %, there is a possibility that the electrostatic capacitance retention rate of the composite manufactured through the subsequent steps is reduced.

In step 1, the carbon source may be included at a concentration of 0.1 to 0.3 wt %, preferably at a concentration of 0.2 wt % in the suspension. When the concentration of the carbon source is less than 0.1 wt %, there is a possibility that the charge and discharge characteristics of the electrode containing the composite manufactured through the subsequent steps are deteriorated, and when the concentration of the carbon source is more than 0.3 wt %, there is a possibility that the electrostatic capacitance of the electrode including the composite prepared through the subsequent steps is reduced.

In step 1, the graphene oxide may be included at a concentration of 0.1 to 0.3 wt %, preferably at a concentration of 0.2 wt % in the suspension. If the concentration is out of the above range, there may be a problem that in the silicon-carbon-graphene composite manufactured through a subsequent step, graphene does not sufficiently encapsulate silicon, or the interface resistance between the electrolyte and the composite increases in a secondary battery including the composite.

In order to prepare silicon, carbon source, and graphene oxide into a suspension, a stirring process may be performed so that reactants are well dispersed in a solvent. At this time, the stirring process may be performed using an ultra-sonication or a mechanical homogenizer.

Since the graphene oxide may perform the role of a dispersant during the production of a mixed solution, it is not necessary to separately add a dispersant for dispersion, so that the process steps are simplified and economic efficiency is improved.

Further, silicon, carbon source and graphene oxide can be mixed by a single process to prepare a suspension. Thereby, the process is simplified and the economic efficiency is improved as compared with the existing technology, in which the process must be performed multiple times, like mixing the graphene oxide after forming the silicon-carbon atom composite.

As a solvent for preparing the suspension, a solvent commonly used in the art may be used, and examples thereof may be one or more combinations selected from the group consisting of distilled water, acetone, methyl ethyl ketone, methyl alcohol, ethyl alcohol, isopropyl alcohol, butyl alcohol, ethylene glycol, polyethylene glycol, tetrahydrofuran, dimethylformamide, dimethylacetamide, N-methyl-2-pyrrolidone, hexane, cyclohexanone, toluene, chloroform, dichlorobenzene, dimethylbenzene, trimethylbenzene, pyridine, methylnaphthalene, nitromethane, acrylonitrile, octadecylamine, aniline and dimethylsulfoxide. Preferably, distilled water can be used.

In the method of manufacturing a silicon-carbon-graphene composite according to an aspect of the present disclosure, in step 2 (S200), the suspension is subjected to an aerosol process to form a silicon-carbon source-graphene oxide composite.

The aerosol process may be performed through the steps of spraying a suspension composed of silicon, carbon source and graphene oxide with aerosol droplets through a nozzle and drying the sprayed material by passing through a tubular heating furnace via a carrier gas.

During spraying, the flow rate of the solution, the spraying pressure, and the spray speed may be appropriately adjusted according to the method and the desired average particle size of the composite, respectively.

The aerosol process has the advantage of being capable of being mass-produced easily and quickly by a single continuous process when manufacturing a three-dimensional shaped composite.

By spraying with aerosol droplets through the nozzle, the liquid can be atomized by mixed dispersion due to the collision of liquid and gas, and unlike the conventional direct pressurized type nozzle, there is an advantage capable of maintaining the spraying of ultrafine particles even at a low pressure.

When the liquid droplets are transferred to a heating furnace, they may be transferred via one or more gases selected from the group consisting of argon gas, helium gas and nitrogen gas, preferably via argon gas.

The flow rate of the gas injected into the nozzle when transferring the droplets to the furnace may range from 5 L/min to 15 L/min, and preferably from 5 L/min to 10 L/min. The above-mentioned carrier gas flow rate and droplet flow rate can facilitate drying and self-assembly of the droplets, and energy waste can be minimized.

The temperature of the aerosol process of step 2 may be 150° C. to 250° C., preferably 180° C. to 220° C. If the drying temperature is less than 150° C., there may be a problem that some of the solvent remains without being evaporated in the liquid droplets, and a problem may occur wherein graphene having a crumpled form cannot easily form an agglomerated graphene oxide layer. If the temperature of the heating furnace exceeds 250° C., an excessive energy waste may be generated in forming a composite including a graphene oxide layer.

When the solvent existing within the liquid droplet are evaporated by the drying through an aerosol process, the graphene oxide sheets are gathered together by a capillary molding phenomenon, the graphene oxide sheets are gathered together, thereby enabling a graphene layer having a crumpled form to be formed on a silicon-carbon composite.

In the method of manufacturing a silicon-carbon-graphene composite according to an aspect of the present disclosure, in step 3 (S300), the silicon-carbon source-graphene oxide composite is heat-treated to form a silicon-carbon-graphene composite.

The silicon-carbon source-graphene oxide composite obtained in step 2 may be heat-treated to perform a reduction of graphene oxide and a complete carbonization of carbon source.

The heat-treatment of step 3 may be performed at a temperature of 500° C. to 1000° C., preferably at a temperature of 600° C. to 900° C., more preferably at a temperature of 800° C.

If the heat-treatment temperature is less than the above range, here is a possibility that the reduction efficiency of graphene oxide and the carbonization efficiency of the carbon source may be lowered. If the heat-treatment temperature exceeds the above range, excessive energy waste may be generated in the process of reducing the graphene oxide and carbonizing the carbon source.

The heat-treatment of step 3 may be performed in a muffle furnace, and may be performed in a gas environment selected from the group consisting of argon, helium and nitrogen, and preferably in an argon gas atmosphere.

During the heat-treatment of step 3, the gas may show a predetermined flow rate, and the flow rate range is not limited as long as the flow rate of the gas can facilitate a heat treatment for reduction and carbonization.

The heat-treatment of step 3 may be performed for 10 minutes to 100 minutes, preferably for 15 minutes to 80 minutes, more preferably for 60 minutes.

If the heat treatment time is less than the above range, a problem may occur in that the graphene oxide is not effectively reduced. If the heat treatment time exceeds the above range, excessive energy waste may be generated in the process of reducing the graphene oxide.

Through the above-mentioned manufacturing method (steps 1 to step 3), the double carbon-graphene coating layer formed around the silicon particles can prevent formation of an unstable solid electrolyte interface (SEI) on the surface of silicon due to the decomposition reaction of lithium ions and electrolyte solution during the charging/discharging of a lithium secondary battery. Thereby, along with the progess of charge/discharge cycles, it can perform the role of keeping the electric capacity constant without decreasing the capacity, and accept a large volume change of silicon.

### Silicon-Carbon-Graphene Composite and Lithium Ion Secondary Battery Using the Same

Another aspect of the present disclosure provides a silicon-carbon-graphene composite comprising: silicon, carbon and graphene, wherein the composite has a crumpled spherical shape including a carbon double coating layer in which the graphene and carbon are formed around silicon particles.

The present disclosure provides a anode material for a lithium ion secondary battery using the silicon-carbon-graphene composite manufactured through the series of steps.

Yet another embodiment of the present disclosure provides a secondary battery comprising an cathode; a anode material including the silicon-carbon-graphene composite; a binder; a separator that is provided between the cathode and the anode; and an electrolyte.

The average particle size of the silicon-carbon-graphene composite may be 2 to 3 μm.

The standard deviation of particle size of the silicon-carbon-graphene composite may be 1.2 to 1.3.

According to the present disclosure, a silicon-carbon-graphene composite having a uniform size can be manufactured regardless of the size of the silicon particles.

As the anode material, the silicon-carbon-graphene composite of the present disclosure can be used alone, or may be used in a mixture with a conventionally used anode material.

The cathode material of the present disclosure may be mixed with a binder, a dispersant, etc. and stirred to prepare a slurry, which may then be applied to a current collector to produce a anode. Usually, it can be produced by the production method of the anode used in the art.

The commonly used anode material may be a mixture of one or more selected from the group consisting of graphite, soft carbon, hard carbon, and lithium titanium oxide.

The binder used herein may be vinylidene fluoride-co-hexafluoropropylene copolymer (PVDF-co-HEP), polyvinylidenefluoride, polyacrylonitrile, polymethylmethacrylate, polyvinyl alcohol, carboxymethylcellulose (CMC), starch, hydroxypropyl cellulose, regenerated cellulose, polyvinylpyrrolidone, tetrafluoroethylene, polyethylene, polypropylene, polyacrylic acid, ethylene-propylene-diene monomer (EPDM), sulfonated EPDM, styrene butadiene rubber (SBR), fluorine rubber or various copolymers, etc.

The cathode used herein may include a layered compound such as lithium cobalt oxide (LiCoO₂), lithium nickel oxide (LiNiO₂) or a compound substituted with one or more transition metals; lithium manganese oxide; lithium copper oxide (Li₂CuO₂); vanadium oxide; Ni-site type lithium nickel oxide; lithium manganese composite oxide; lithium oxide in which a part of Li in the chemical formula is substituted with an alkaline earth metal ion, but is not limited thereto.

As the separator, a porous polymer film commonly used for separators, for example a porous polymer film made of polyolefin polymers, such as ethylene homopolymers, propylene homopolymers, ethylene/butane copolymers, ethylene/hexane copolymers and ethylene/methacrylate copolymers may be used alone, or may be used by laminating these films. For example, a conventional porous non-woven fabric, for example, a non-woven fabric made of high melting-point glass fiber, polyethylene terephthalate fiber and the like can be used, but is not limited thereto.

In the electrolyte used in the present disclosure, lithium salts that may be included as an electrolyte may be used without limitation as long as they are those commonly used in electrolytes for secondary batteries.

In the electrolyte used in the present disclosure, organic solvents included in the electrolyte may be used without limitation as long as they are those commonly used. Typically, any one selected from the group consisting of propylene carbonate, ethylene carbonate, diethyl carbonate, dimethyl carbonate, ethyl methyl carbonate, methyl propyl carbonate, dipropyl carbonate, dimethyl sulfoxide, acetonitrile, dimethoxyethane, diethoxyethane, vinylene carbonate, sulfolane, gamma-butyrolactone, propylene sulfite and tetrahydrofuran, or a mixture of two or more thereof may be used.

Optionally, the electrolyte stored according to the present disclosure may further include additives such as an overcharge inhibitor contained in a conventional electrolyte.

A separator is disposed between the cathode and the anode to form a battery structure, and the battery structure is wound or folded and placed in a cylindrical battery case or a square battery case, and then an electrolyte is injected to complete a secondary battery. Alternatively, the battery structure is stacked into a bi-cell structure, which is then impregnated with the electrolyte, and the resulting product is added and sealed in a pouch to complete the secondary battery.

The lithium ion secondary battery using the silicon-carbon-graphene composite of the present disclosure exhibits high discharge capacity and excellent coulombic efficiency.

This is because the structure in which carbon and graphene are double-wrapped around the silicon particles contained in the composite well accepts the volume change according to the change in the particle size of the silicon in the composite during charging/discharging, thereby maintaining the electrostatic capacitance of the composite well.

In addition, since carbon is double-coated onto the silicon surface, it can improve the electrical conductivity, prevents pulverization of silicon, prevent the formation of unstable solid electrolyte layer in a large amount, maintain a rigid electrode structure, exhibit excellent cycling performance and stability, and improve electrochemical properties.

Hereinafter, the present disclosure will be described in more detail by way of examples and experimental examples. However, the following examples and experimental examples are for illustrative purposes only and are not intended to limit the scope of the present disclosure.

### EXAMPLE

### Preparation Example 1: Sample Preparation

For the preparation of the silicon-carbon-graphene composite powder, four types of silicon powders having an average particle size of 50 nm, 100 nm, 200 nm, and 1 μm were used. For silicon having a particle size of 50 nm and 100 nm, commercially available silicon powders were purchased from Alfa aesar (98%) and Sigma Aldrich (98%), respectively.

For silicon having a particle size of 1 μm or more, silicon particles (99%) generated in the wafer cutting process for solar cells were used. For silicon having a particle size of 200 nm, it was prepared by pulverizing and dispersing silicon of 1 μm or more using a bead mill. In addition, the graphene oxide (GO) used for the manufacture of the composite was prepared according to a modified Hummer's method and then dispersed in distilled water. Glucose was used as the carbon source for the composite.

### Preparation Example 2: Preparation of Silicon-Carbon-Graphene (Si—C-GR) Composite

### Example 1

Step 1: Silicon (98%, Alfa aesar) having a particle size of 50 nm, glucose as a carbon source, and graphene oxide prepared by a Modified Hummers method were subjected to ultra-sonication and dispersed to prepare a silicon-glucose-graphene oxide suspension. At this time, the concentration of silicon was set to 0.3 wt %, the concentration of glucose as a carbon raw material to 0.2 wt %, and the concentration of graphene oxide to 0.2 wt %.

Step 2: The silicon-glucose-graphene oxide suspension prepared in step 1 was subjected to an aerosol process to prepare a silicon-glucose-graphene oxide composite. At this time, the reactor temperature of the aerosol process was 200° C., and the transport gas was Ar and was injected at a flow rate of 10 L/min.

Step 3: The silicon-glucose-graphene oxide composite prepared in step 2 was heat-treated at 800° C. for 1 hour under the Ar gas injection in order to reduce graphene oxide to graphene and to carbonize glucose to carbon.

### Example 2

A silicon-carbon-graphene composite was prepared in the same manner as in Example 1, except that in step 1 of Example 1, the silicon was changed to silicon having a particle size of 100 nm (98%, Sigma Aldrich).

### Example 3

Step 1: Silicon (99%) having a particle size of 1 μm or more generated in a wafer cutting process for a solar cell was pulverized and dispersed using a bead mill to prepare a silicon having a particle size of 200 nm. Silicon, glucose as a carbon source, and graphene oxide prepared by a Modified Hummers method were subjected to ultra-sonication and dispersed to prepare a silicon-glucose-graphene oxide suspension. At this time, the concentration of silicon was set to 0.3 wt %, the concentration of glucose as a carbon raw material to 0.2 wt %, and the concentration of graphene oxide to 0.2 wt %.

Step 2: The silicon-glucose-graphene oxide suspension prepared in step 1 was subjected to an aerosol process to prepare a silicon-glucose-graphene oxide composite. At this time, the reactor temperature of the aerosol process was 200° C., and the transport gas was Ar and was injected at a flow rate of 10 L/min.

Step 3: The silicon-glucose-graphene oxide composite prepared in step 2 was heat-treated at 800° C. for 1 hour under the argon gas injection in order to reduce graphene oxide to graphene and to carbonize glucose to carbon.

### Example 4

Step 1: Silicon (99%) having a particle size of 1 μm generated in a wafer cell cutting process was prepared. Silicon, glucose as a carbon source, and graphene oxide prepared by a Modified Hummers method were subjected to ultra-sonication and dispersed to prepare a silicon-glucose-graphene oxide suspension. At this time, the concentration of silicon was set to 0.3 wt %, the concentration of glucose as a carbon raw material to 0.2 wt %, and the concentration of graphene oxide to 0.2 wt %.

Step 2: The silicon-glucose-graphene oxide suspension prepared in step 1 was subjected to an aerosol process to prepare a silicon-glucose-graphene oxide composite. At this time, the reactor temperature of the aerosol process was 200° C., and the transport gas was Ar and was injected at a flow rate of 10 L/min.

Step 3: The silicon-glucose-graphene oxide composite prepared in step 2 was heat-treated at 800° C. for 1 hour under the Ar gas injection in order to reduce graphene oxide to graphene and to carbonize glucose to carbon.

### EXPERIMENTIAL EXAMPLE

### Experimental Example 1: FE-SEM Analysis of Silicon-Carbon-Graphene Composite

In order to observe the shapes of the silicon-carbon-graphene composites prepared in the Examples, FE-SEM (Field-Emission Scanning Electron Microscopy; Sirion, FEI) analysis was performed.

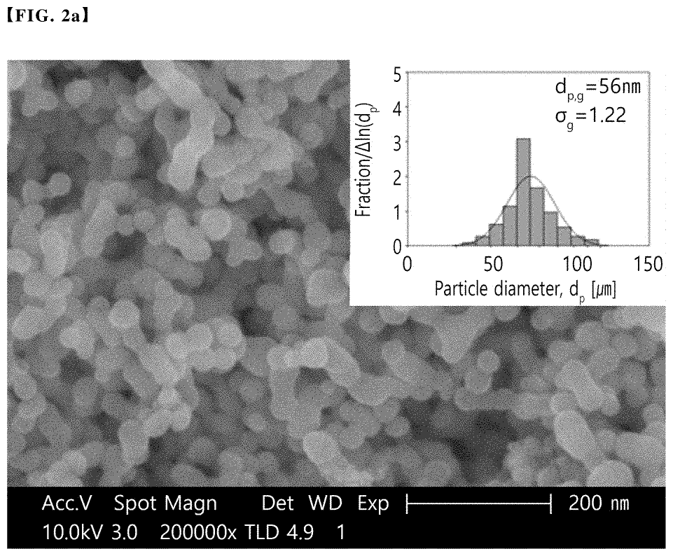

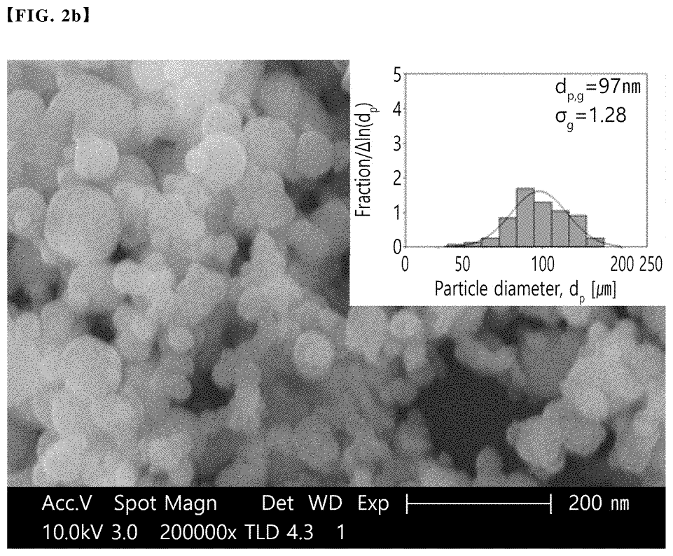

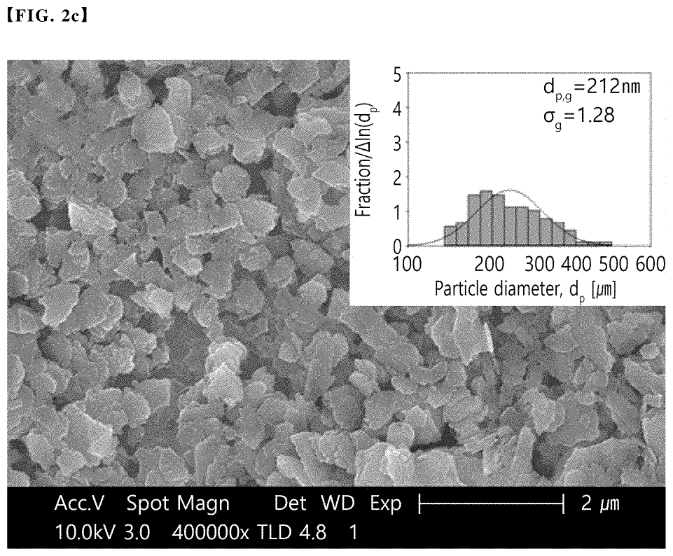

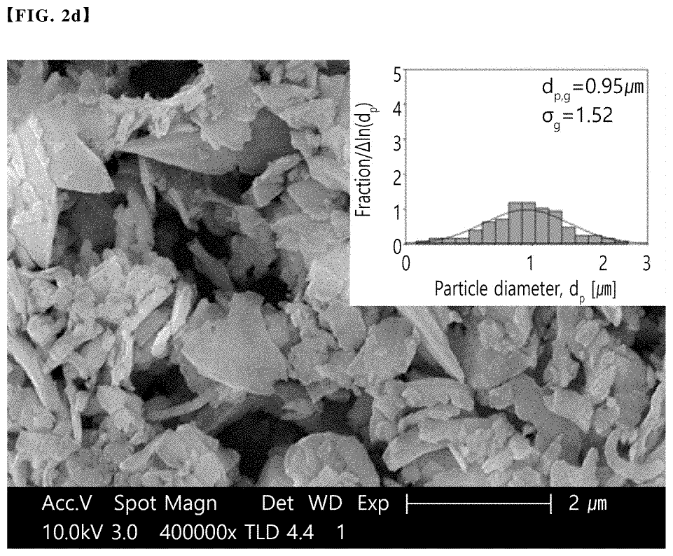

FIG. 2a to FIG. 2d show FE-SEM images of silicon raw materials based on a particle size (FIG. 2a 50 nm, FIG. 2b 100 nm, FIG. 2c 200 nm, FIG. 2d 1 μm).

Referring to FIG. 2a to FIG. 2d, it can be confirmed that silicons having particle sizes of 50 nm and 100 nm exhibit a spherical shape. Even in the case of the particle size of 200 nm, particles having a substantially uniform distribution can be confirmed. However, it can be confirmed that in the case of the particle size of 1 μm, it is a polygonal shape, and exhibits a non-uniform particle size distribution.

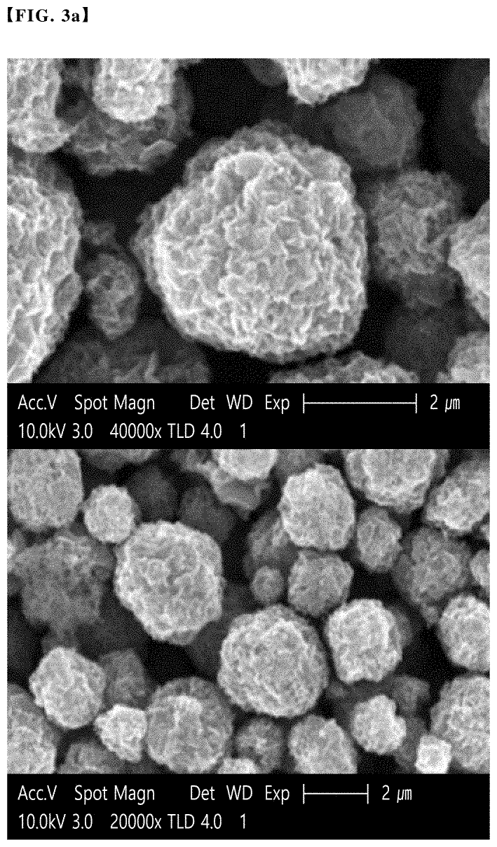

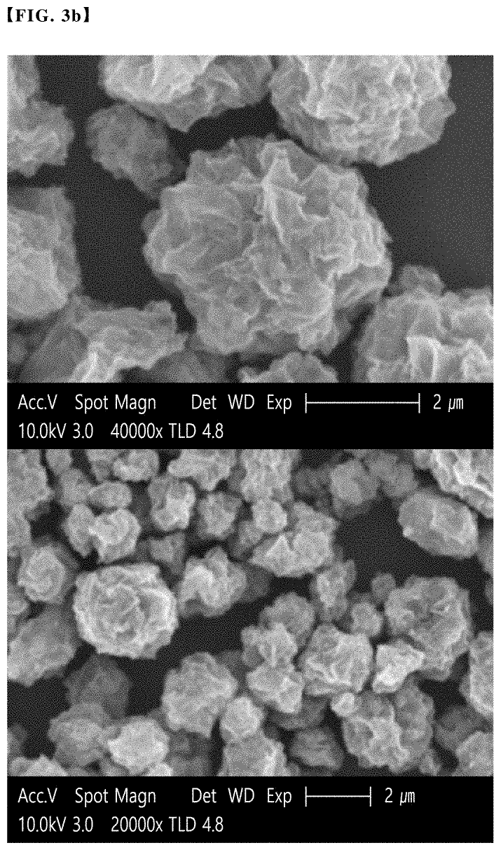

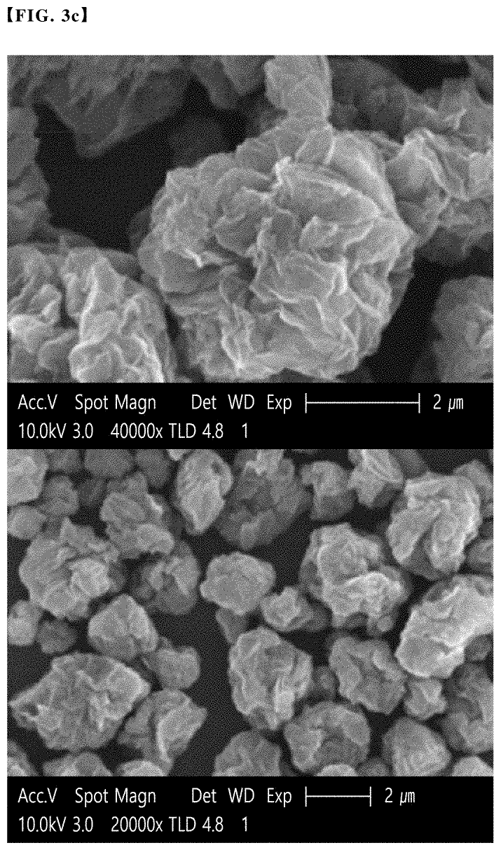

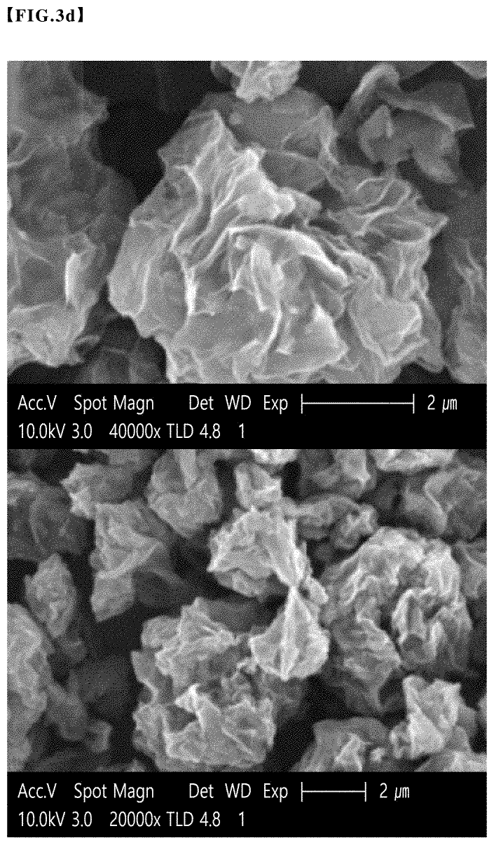

FIG. 3a to FIG. 3d show FE-SEM images of the silicon-carbon-graphene composites based on particle sizes of silicon (FIG. 3a 50 nm, FIG. 3b 100 nm, FIG. 3c 200 nm, FIG. 3d 1 μm).

Referring to FIG. 3a to FIG. 3d, it can be confirmed that the silicon-carbon-graphene composite is spherical regardless of the size of the silicon particles under all conditions.

In addition, a shape in which silicon and carbon are completely wrapped by graphene is observed. It can be confirmed that as the particle size of silicon is smaller, it shows a spherical shape densely packed with silicon and carbon therein.

These results are because as the particle size of the silicon in the silicon-carbon-graphene composite is smaller, the number of silicones that can be distributed within one droplet in the aerosol process is increased, so the composite has a fully packed spherical shape.

### Experimental Example 2: Analysis of Particle Size of Silicon-Carbon-Graphene Composite

In order to confirm the particle size of the silicon-carbon-graphene composite prepared in the Examples, 200 representative particles were selected and measured from the FE-SEM analysis results of Experimental Example 1, and the average size and distribution map of the particles were measured.

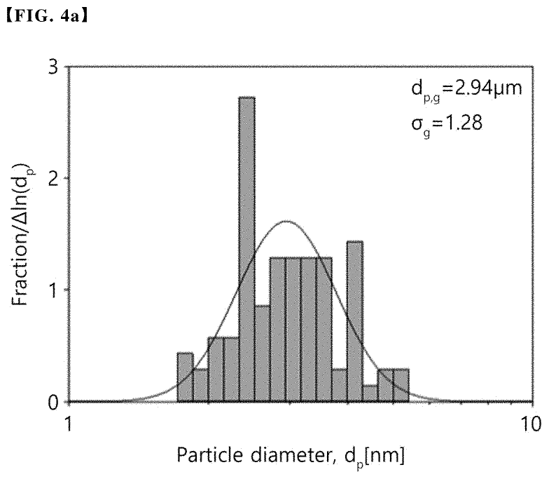

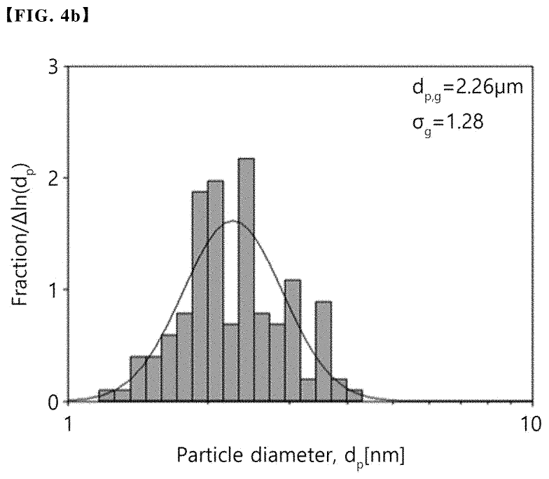

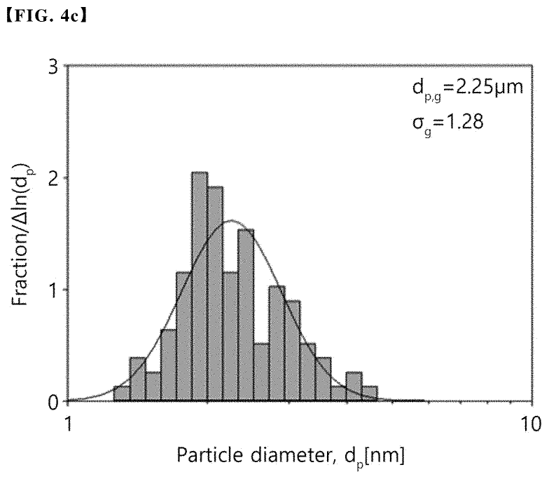

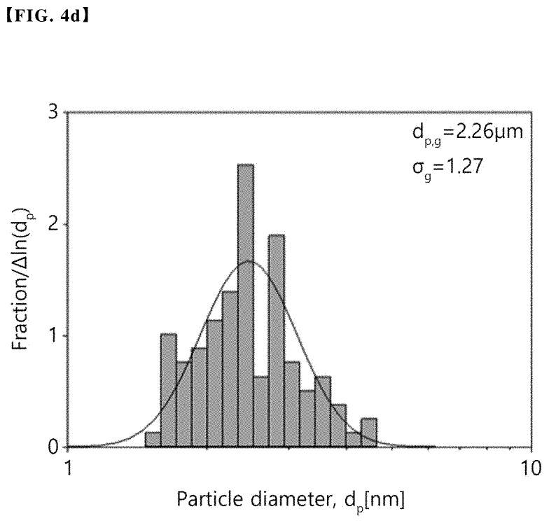

FIG. 4a to FIG. 4d are a graph showing the average particle size and distribution of silicon-carbon-graphene composites based on particle sizes of silicon (FIG. 4a 50 nm, FIG. 4b 100 nm, FIG. 4c 200 nm, FIG. 4d 1 μm).

Referring to FIG. 4a to FIG. 4d, it can be confirmed that the size of the silicon-carbon-graphene composite generally exhibits a distribution map of 1 to 5 μm regardless of the particle size of the raw material silicon.

Further, the average particle size (d_{p,g}) of the silicon-carbon-graphene composite is about 2.2 to 2.9 μm, which does not show a large change. From this result, it can be confirmed that the particle size of the silicon as a raw material does not significantly affect the size of the composite.

In addition, it can be confirmed that since the standard deviation (σ_{g}) of the particle size distribution of the silicon-carbon-graphene composite also shows mostly 1.27 to 1.28, the size of the produced particles is relatively uniform.

### Experimental Example 3: XRD and Raman Analysis of Silicon-Carbon-Graphene Composite

For the silicon-carbon-graphene composites prepared in the Examples, the crystalline phase of silicon and carbon in the composite was confirmed using X-ray diffractometer (XRD; Dimension P1, Lamda solution Inc.) and Raman spectroscopy (Dimension P1, Lamda solution Inc.).

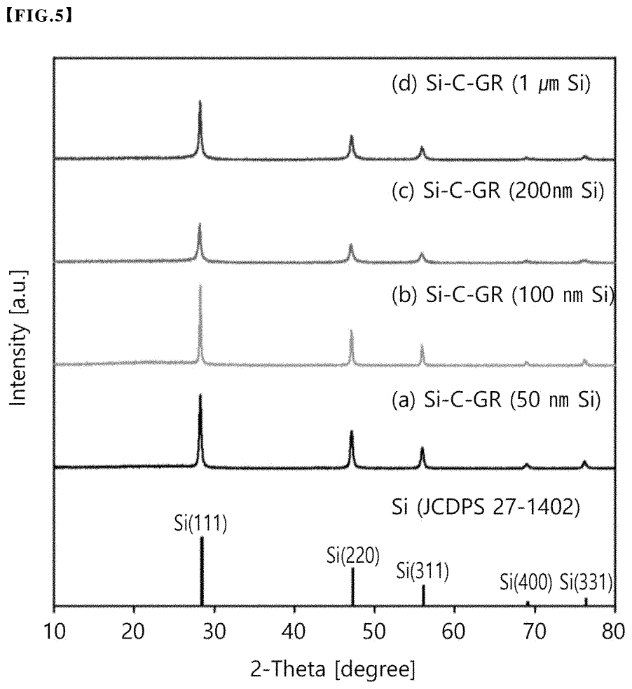

FIG. 5 is a graph showing the results of XRD analysis of silicon-carbon-graphene composites prepared based on particle sizes of silicon ((a) 50 nm, (b) 100 nm, (c) 200 nm (d) 1 μm).

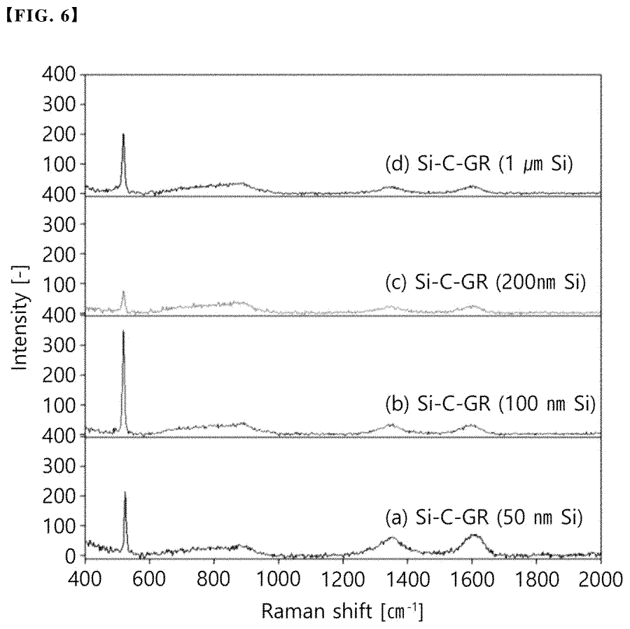

FIG. 6 is a graph showing the results of Raman spectroscopy analysis of silicon-carbon-graphene composites prepared based on particle sizes of silicon ((a) 50 nm, (b) 100 nm, (c) 200 nm (d) 1 μm).

Referring to FIG. 5, it was confirmed that a crystalline phase peak of silicon strongly appeared at about 28 under all conditions, but the crystalline phase of graphene and carbon was not confirmed.

Generally, the crystalline phase of graphene appears broadly around 25, but in the case of carbon and graphene in the silicon-carbon-graphene composite, it is considered that the crystalline phase is relatively low and invisible compared to silicon.

In addition, in the case of a composite using commercial silicon having a particle size of 50 nm and 100 nm, it can be confirmed that the crystallin phase of silicon is stronger than the composite using silicon sludge.

Meanwhile, referring to FIG. 6, it can be confirmed that the peaks corresponding to the silicon appear at about 520 cm⁻¹, the D and G peaks corresponding to carbon and graphene appear at about 1350 cm⁻¹ and 1600 cm⁻¹, respectively. The D peak is a peak showing the defect of carbon and graphene, and the G peak is a peak showing the sp2 double bond of carbon.

Therefore, the presence of carbon and graphene, which could not be confirmed by XRD, can be confirmed through Raman spectroscopy.

### Experimental Example 4: Evaluation of Electrochemical Properties of Silicon-Carbon-Graphene Composite

In order to evaluate the characteristics of the lithium ion secondary battery composed of the silicon-carbon-graphene composite prepared in the Examples, a charge/discharge test (Galvanostatic charge/discharge measurement, TOSCAT3000, Toyo) was performed using a CR2032 type coin cell.

The reference electrode of the coin cell was lithium metal, and the coating condition was set so that the weight ratio of the electrode material, the active material, and the binder (Solvay) was performed at 80:10:10 wt %. The measurement range was set to 0.001 to 2.0 V (V vs Li/Li⁺), and the current density was set to 0.2 A/g. As the electrolyte, 1.0 M LiPF6 ethylene carbonate solution (EC) and dimethyl carbonate (DMC) were mixed at a ratio of 1:1 vol % and used. As the separation membrane, a microporous glass-fiber membrane (Whatman) was used.

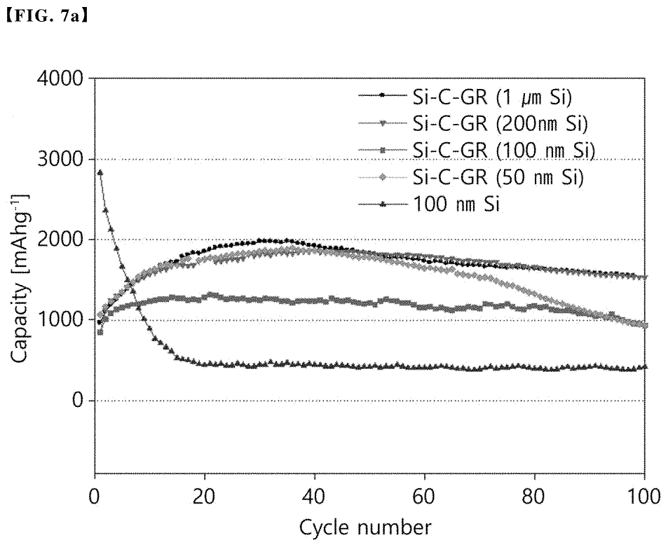

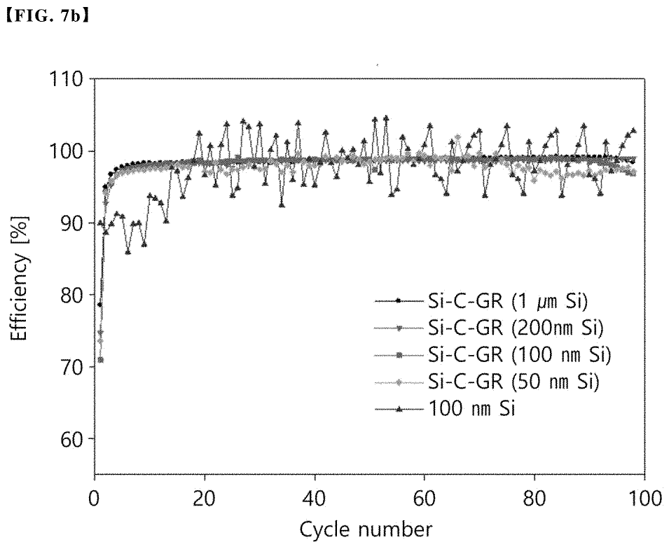

FIG. 7a is a graph comparing the electric capacities of a lithium ion secondary batteries composed of silicon-carbon-graphene composites prepared based on silicon particle sizes.

FIG. 7b is a graph comparing the Coulombic efficiencies of a lithium ion secondary batteries composed of silicon-carbon-graphene composites prepared based on silicon particle sizes.

Referring to FIG. 7a, the initial capacitances of the silicon-carbon-graphene composites using silicon having a particle size of 50 nm, 100 nm, 200 nm, and 1 μm are about 1050, 800, 800, and 950 mAh/, respectively, confirming that it has a lower value than the initial capacity using only pure silicon having a particle size of 100 nm.

Further, when only pure silicon particles were used, the initial value was as high as 2800 mAh/g, but it was confirmed that it decreases sharply as charging and discharging progress. In particular, after 20 cycles, it can be confirmed that the capacity value rapidly drops to 500 mAh/g.

This is because when only silicon particles are used, it exhibits a high packing density in a solid state, inhibits the movement of the electrolyte, and exhibits low cycle stability because it cannot accept large volume changes of silicon during charging/discharging.

When the silicon-carbon-graphene composite produced according to the present disclosure is used, during 100 charge/discharge cycles, it exhibits the capacities of 932, 930, 1532, and 1546 mAh/g in the order of silicon-carbon-graphene compositess using silicon particles of 50 nm, 100 nm, 200 nm, and 1 μm, respectively, confirming that it has a superior capacity ability than pure silicon.

This excellent capacity is considered to be because the structure in which the silicon particles contained in the composite are wrapped with carbon and graphene well accepts the volume change based on the particle size change of the silicon of the composite during charging/discharging, thereby maintaining the capacitance of the composite well.

In particular, carbon is doube-coated on the silicon surface, which improves the electrical conductivity, prevents the pulverization of silicon, prevents the formation of unstable solid electrolyte layers in large amounts, maintains a rigid electrode structure, and improves electrochemical properties.

Meanwhile, looking at the electrochemical properties of the composite during 100 charge/discharge cycles, it was found that in the case of the electrode made of a composite containing a particle size of 200 nm or more, it was maintained at 1500 mAh/g or more, and it can be confirmed that the composite containing silicon having a particle size of 100 nm or less exhibits a value of 1000 mAh/g or less.

The numerical concentration of particles having a silicon size of 100 nm or less in the composite manufactured at a constant silicon weight concentration is higher than those of particles having a size of 200 nm or more, so the amount of solid electrolyte layer generated on the entire particle surface during charging/discharging is relatively large. As a result, it is considered that the particle surface resistance increases, the charge transfer decreases, thus exhibiting a low capacitance.

Referring to FIG. 7b, the result of analyzing the Coulombic efficiency of the prepared silicon-carbon-graphene composite showed that the efficiency was maintained at about 95% or more for 100 cycles under all conditions, but the composites containing silicon particles of 100 nm or less shows a tendency that the coulombic efficiency slightly decreases at 100 cycles, whereas the composite containing silicon having a particle size of 200 nm or more continuously shows excellent cycling performance and stability of 99% or more.

Although the invention has been described in connection with what is presently considered to be practical examplary embodiments of a silicon-carbon-graphene composite and a manufacturing method thereof, and a lithium ion secondary battery using the same according to the present disclosure, it will be apparent that the invention is intended to cover various modifications included within the sprit and scope of the present disclosure.

Therefore, the scope of the present disclosure should not be construed as being limited to the embodiments described, but should be determined by equivalents of the appended claims, as well as the following claims.

That is, it is to be understood that the foregoing embodiments are illustrative and not restrictive in all respects and that the scope of the present disclosure is indicated by the appended claims rather than the foregoing description, and all changes or modifications derived from the equivalents thereof should be construed as being included within the scope of the present disclosure.

1. A method for manufacturing a silicon-carbon-graphene composite comprising the steps of:
preparing a suspension in which silicon, carbon source and graphene oxide are dispersed (step 1);
subjecting the suspension to an aerosol process to form a silicon-carbon source-graphene oxide composite (step 2); and
heat-treating the silicon-carbon source-graphene oxide composite to form a silicon-carbon-graphene composite (step 3).

2. The method of claim 1,
wherein the silicon in step 1 is obtained from silicon sludge generated in silicon wafer manufacturing process.

3. The method of claim 1,
wherein the silicon in step 1 is obtained by pulverizing and dispersing silicon having an average particle size of 1 μm or more.

4. The method of claim 1,
wherein the silicon in step 1 has an average particle size of 50 nm to 1 μm.

5. The method of claim 1,
wherein carbon source in step 1 includes one or more selected from the group consisting of monosaccharides, disaccharides, polysaccharides, polyvinylpyrrolidone (PVP), polyethylene glycol (PEG), and polyvinyl alcohol (PVA).

6. The method of claim 1,
wherein a concentration of the silicone in step 1 is 0.1 to 0.5 wt % with respect to the suspension.

7. The method of claim 1,
wherein a concentration of the carbon source in step 1 is 0.1 to 0.3 wt % with respect to the suspension.

8. The method of claim 1,
wherein a concentration of the graphene oxide in step 1 is 0.1 to 0.3 wt % with respect to the suspension.

9. The method of claim 1,
wherein the aerosol process is performed through the steps of spraying the suspension with aerosol droplets through a nozzle and drying the sprayed material by passing through a tubular heating furnace via a carrier gas.

10. The method of claim 9,
wherein the carrier gas is one or more gases selected from the group consisting of argon, helium and nitrogen.

11. The method of claim 9,
wherein a flow rate of the carrier gas is 5 L/min to 15 L/min.

12. The method of claim 1,
wherein the aerosol process in step 2 may be performed at a temperature of 150° C. to 250° C.

13. The method of claim 1,
wherein the heat-treatment of step 3 is performed at a temperature of 500° C. to 1000° C.

14. A silicon-carbon-graphene composite comprising: silicon, carbon and graphene, wherein the composite has a crumpled spherical shape including a carbon double coating layer in which the graphene and carbon are formed around silicon particles

15. The silicon-carbon-graphene composite of claim 14,
wherein the silicon has an average particle size of 50 nm to 1 μm.

16. The silcon-carbon-graphene composite of claim 14,
wherein the silicon-carbon-graphene composite has an average particle size of 2 μm to 3 μm.

17. The silicon-carbon-graphene composite of claim 14,
wherein the carbon includes one or more selected from the group consisting of monosaccharides, disaccharides, polysaccharides, polyvinylpyrrolidone (PVP), polyethylene glycol (PEG), and polyvinyl alcohol (PVA).

18. A lithium ion secondary battery comprising an cathode; a anode material including the silicon-carbon-graphene composite of claim 14; a separator that is provided between the cahode and the anode; and an electrolyte.

19. The method of claim 9,
wherein the aerosol process in step 2 may be performed at a temperature of 150° C. to 250° C.

20. The method of claim 9,
wherein the heat-treatment of step 3 is performed at a temperature of 500° C. to 1000° C.
